(19) United States
(12) Patent Application Publication
(10) Pub. No.: US 2004/0205029 A1
(43) Pub. Date: Oct. 14, 2004

(54) Method for securely purchasing goods and/or services over the internet

(75) Inventors: Thomas M. Stephany, Churchville, NY (US); Jacob L. Pietruszewski, Penfield, NY (US); Yawcheng Lo, Rochester, NY (US); Peyton C. Watkins, Penfield, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/411,992

(22) Filed: Apr. 11, 2003

(51) Int. Cl. G06F 17/60

(52) U.S. Cl. 705/71

(57) ABSTRACT

A method for securely purchasing goods and services over the Internet, the method includes receiving an online form that was completed over the Internet for the purchase of goods or services; wherein the received completed document included a signature that was encrypted by a private key; sending the completed form with the attached signature to a charge clearinghouse which verifies the signature via the public key and authorizes a purchase with a unique authorization code; receiving the unique authorization code embedded and inseparable from the completed document from the charge clearinghouse; and issuing the goods or performing the service.

### FIELD OF THE INVENTION

The invention relates generally to the field of commercial transactions and, more particularly, to such transactions in which a secure digital signature enables electronic online forms for the purchase of goods and services and eliminates the need to transmit credit card information over the Internet through the use of a unique authorization code.

### BACKGROUND OF THE INVENTION

Currently, in commercial transactions, an individual searches the Internet and completes an online form for purchasing only goods or services. The online form includes portions in which credit card information is input. Obviously, the credit card information is transmitted over the Internet with the completed online form. The user then receives their goods or services.

Although the above-described transaction is satisfactory, obviously theft of credit card information is undesirable. In the event of theft, the credit card could have thousands of unauthorized charges before even knowing of the theft.

Consequently, a need exists for completing Internet-based commercial transactions, which reduces the risk of credit card theft.

### SUMMARY OF THE INVENTION

The present invention is directed to overcoming one or more of the problems set forth above. Briefly summarized, according to one aspect of the present invention, the invention resides in a method for securely purchasing goods and services over the Internet, the method includes receiving an online form that was completed over the Internet for the purchase of goods or services; wherein the received form included a signature that was encrypted by a private key; sending the completed form with the attached signature to a charge clearinghouse which verifies the signature via the public key and authorizes a purchase with a unique authorization code; receiving the unique authorization code from the charge clearinghouse; and issuing the goods or performing the service.

These and other aspects, objects, features and advantages of the present invention will be more clearly understood and appreciated from a review of the following detailed description of the preferred embodiments and appended claims, and by reference to the accompanying drawing.

### ADVANTAGEOUS EFFECT OF THE INVENTION

It is an advantage of the present invention to solve the problem of unauthorized use of credit cards and associated credit card theft. Since the submission of a credit card number and its expiration date exposes the user to potential multiple charges before a theft is detected. It is preferable to use a unique transaction number rather than a credit card number and expiration date to accomplish a purchase. The above invention negates the need to give a business a credit card number and an expiration date to accomplish the purchase.

### BRIEF DESCRIPTION OF THE DRAWINGS

FIG. 1 is a process flowchart of the present invention.

### DETAILED DESCRIPTION OF THE INVENTION

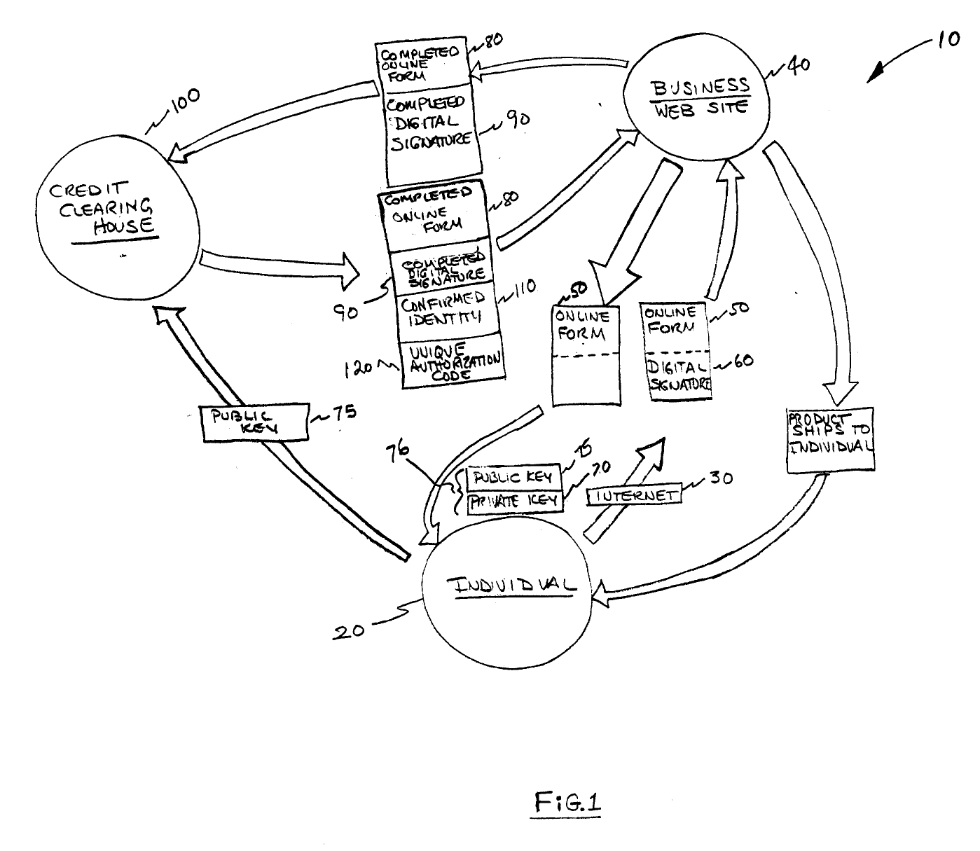

Referring to FIG. 1, there is shown a process flowchart 10 of the present invention. In this regard, an individual 20 searches the Internet 30 for Web sites 40 offering products and services of interest to the individual. When such a useful Web site 40 is found, the individual indicates to the Web site 40, by typical Internet methods, their intent to purchase a product or service. The business Web site 40 includes an online form 50 that is sent to the individual 20 over the Internet 30 for completion. The online form 50 is electronically completed in the personal computer of the individual or business, and is signed with a digital signature 60 and encoded by the purchaser's private key 70. The encoding of the electronic form by the private key 70 produces a digital signature 60 that is unique to the individual 20, which possesses the private key 70. It is noted that secure communications between Web sites 40 is accomplished by the use of public 75 and private keys 70. In this regard, public keys 75 can decode only documents sent by the owner of the corresponding private key 70 so that authenticity is guaranteed. In this regard, the Web sites 40 will have the public key 75 for such decoding.

It is also instructive to note that since the individual 20 generates their own public/private key pairs 76, the individual 20 can generate a key pair 76 at any time of their choosing. With this said, a key pair 76 could be generated for each transaction, randomly or at predetermined times, and the public key 75 is transmitted to both the business Web site 40 and the credit clearinghouse 100 producing an additional level of security.

It facilitates understanding to note that the individual 20 should be personally identified with the public key 75, and the individual 20 must maintain the secrecy of the private key 70. For example, the individual 20 could personally register the public key 75 with the credit clearinghouse 100. In the case of creating a new key pair 76 upon each transaction, the individual 20 would be required to register with the credit clearinghouse 100, or if this was not practical, a lesser level of security would be maintained. The credit clearinghouse 100 would then verify authenticity of a document generated by the individual 20. The document created by the individual 20 using the secret private key 70, can only be read using the public key 75 which is generated at the same time as a key pair 76.

The unique digital signature 60 is attached to the completed online form 50 and sent back to the business Web site 40. The business Web site 40, in receiving the order, needs authorization in order to ship the product or perform the service. To accomplish this, the completed online form 80 with the attached within the completed digital signature 90 is sent to a credit clearinghouse 100. The credit clearinghouse 100 confirms the individual's credit worthiness, and returns the online form with the attached completed digital signature 90 to the business Web site 40 along with a confirmed identity 110 and a unique authorization code 120 for enabling a purchase. The business Web site 40, receiving the form returned from the credit clearinghouse 100, would then ship the goods to the individual 20 or perform the service for the individual 20. It is interesting to note at this point that a valid credit card number or expiration date has not been exchanged at any point through the entire purchasing process. It is also instructive to note that the online form 80, completed digital signature 90, confirmed identity 110 are authorization code 120 inseparable from the document and from each other in order to guarantee the highest security. Instead, an authorization code 120 that is individually unique to the transaction has been used and is useless for any other purpose other than the current transaction.

The invention has been described with reference to a preferred embodiment. However, it will be appreciated that variations and modifications can be effected by a person of ordinary skill in the art without departing from the scope of the invention.

### Parts List

10 process flowchart

20 individual

30 Internet

40 Web site

50 online form

60 digital signature

70 private key

75 public key

76 public/private key pair

80 completed online form

90 completed digital signature

100 credit clearinghouse

110 confirmed identity

120 unique authorization code

1. A method for securely purchasing goods and/or services over the Internet, the method comprising:
(a) receiving an online form that was completed over the Internet for the purchase of goods or services; wherein the received form included a signature that was encrypted by a private key;
(b) sending the completed form with the attached signature to a charge clearinghouse which verifies the signature via the public key and authorizes a purchase with a unique authorization code;
(c) receiving the unique authorization code from the charge clearinghouse; and
(d) issuing the goods or performing the service.

2. The method as in claim 1 further comprising storing within the charge clearinghouse a private credit card number assigned to an individual or business.

3. The method as in claim 1 further comprising storing within the charge clearinghouse a public key assigned to an individual or business.

4. The method as in claim 1 further comprising storing within the charge clearinghouse a personal identification of an individual or business.

5. The method as in claim 1 further comprising storing within the charge clearinghouse a personal identification associated not with a credit card but associated with credit worthiness.

6. The method as in claim 5 further comprising issuing an authorization code based upon the credit worthiness and verification of identity.

7. The method as in claim 1 further comprising the step of creating a public and private key pair at random or predetermined times and sending the public key to one or more third parties.

8. The method as in claim 1 further comprising the step of creating a public and private key pair upon each transaction and sending the public key to one or more third parties.

9. The method as in claim 1, wherein the authorization code and signature form are inseparable and/or embedded from the competed form.
